(19) United States
(12) Patent Application Publication
(10) Pub. No.: US 2015/0106202 A1
(43) Pub. Date: Apr. 16, 2015

(54) DYNAMIC AGGREGATION AND MANAGEMENT OF MOBILE APPLICATIONS AND APPLICATION DATA

(71) Applicant: CELLCO PARTNERSHIP D/B/A VERIZON WIRELESS, Basking Ridge, NJ (US)

(72) Inventors: Brigitte BASTALDO-TSAMPALIS, Bridgewater, NJ (US); Ning ZHANG, Warren, NJ (US)

(73) Assignee: CELLCO PARTNERSHIP D/B/A VERIZON WIRELESS, Basking Ridge, NJ (US)

(21) Appl. No.: 14/052,361

(22) Filed: Oct. 11, 2013

(51) Int. Cl. G06Q 30/02

(52) U.S. Cl. CPC G06Q 30/0257; G06Q 30/0267
USPC 705/14.55

(57) ABSTRACT

A mobile station configured to communicate across a mobile wireless communication network has a plurality of retail applications installed thereon. A retail application aggregator running on the mobile station is operative to dynamically manage the retail applications and aggregate data from the retail applications. A user of the mobile station identifies retail applications to include in an application grouping, and filter parameters to associate with the application grouping and used to identify content of interest to the user. For each retail application in the grouping, the aggregator accesses the retail application to obtain information on current offers extended by a retailer associated with the application. The aggregator filters the obtained information on current offers based on the filter parameters, and provides the user with the current offers matching the filter parameters.

### BACKGROUND

Users of mobile devices such as smart-phones are provided with retail applications by retailers such as stores, restaurants, brands, and other businesses. Each retail application provides users with information on a corresponding retailer's products, services, and other offerings, including information on any sales, special offers, and coupons offered by the retailer. In order to learn about multiple retailers' sales, special offers, and coupons, a user must therefore access each of the retailers' applications.

Additionally, retailers frequently update the information on sales, special offers, and coupons, and the sales, special offers, and coupons are generally valid for limited time periods. In order to receive the information from retailers in a timely manner, users must therefore frequently access each retailer's application, and individually sort through each retailer's offerings. Users are therefore faced with a time consuming and burdensome process in order to stay apprised of retailers' current offerings.

A need therefore exists for users to be able to receive, sort, and organize information obtained through multiple retailers' applications in a more efficient manner.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of an example of a system of networks/devices that provide various communications for mobile stations and support for providing dynamic management of mobile applications and aggregation of application data on users' mobile stations.

FIG. 2A is a flow diagram showing steps performed during setup of a retail application aggregator on a mobile station.

FIG. 2B is a flow diagram showing steps performed by a retail application aggregator during operation on a mobile station.

FIGS. 3A-3D are illustrative display screens of a mobile station during setup and use of a retail application aggregator.

FIG. 4 is a high-level functional block diagram of an exemplary mobile station as may run a retail application aggregator for use within a network/system like that shown in FIG. 1.

FIG. 5 is a simplified functional block diagram of a computer that may be configured as a host or server, for example, to function as an aggregator server in the system of FIG. 1.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various methods and systems disclosed herein relate to the dynamic management of mobile applications and aggregation of application data.

A retail application aggregator runs on a user mobile station having a plurality of retail applications installed thereon. The aggregator stores an application grouping identifying at least two of the retail applications, and filter parameters for the application grouping. For each retail application in the grouping, the aggregator accesses the application to obtain information on current offers of the retail application, and filters the obtained information on current offers to determine whether any of the current offers match filter criteria. The aggregator aggregates information on the current offers that match the filter criteria, and provides the aggregated information to the user.

Current offers can include notifications of sales, coupons, and other special offers extended by a retailer, as well as information on new or current products and services of the retailer. In general, current offers are timely, and are released or provided by retailers when a sale begins or a coupon becomes valid, shortly before or after the sale begins or the coupon becomes valid (e.g., a release can occur on a Monday for sales and coupons whose validity begins the following Wednesday), or at another time during a period of validity of a sale or coupon. Current offers can also include advertisements for new or current products and services of the retailer that may or may not have a period of validity, such as an advertisement informing potential customers about a spring clothing collection, a new product release, or the like.

The terms retail and retailer refer generally herein to business-to-consumer ventures that provide not only goods to consumers, but that more generally provide products and services to users. Such products and services may be entertainment, news, gaming, and other commercial and non-commercial products and services.

The aggregator accesses each application in the grouping in response to receiving a user request for updated information on current offers of retail applications in the application grouping, in response to reaching a pre-scheduled time, in response to determining that at least one retail application has updated information on current offers, in response to determining that a user has crossed a geographical boundary, or the like.

The aggregator can access each application by accessing information on current offers that is automatically transmitted to the user mobile station by a server associated with a retail application. The aggregator can also access each application by running the retail application in the background on the mobile station, in order to cause the retail application to retrieve information on current offers from a server associated with the retail application.

A retail application is an application configured to run on a user's mobile station, and to provide the user with information on the retailer's products, services, and other offerings. For example, a retail application can enable a user to view information about the retailer and the retailer's products, and to shop for and purchase the retailer's products. A retail application can additionally provide the user with information on any sales, special offers, and coupons offered by the retailer. In one example, the retail application enables the user to access coupons, for example by downloading the coupons to the user's mobile station for presentation in a store, by causing the coupons to be sent to the user by email or short message service (SMS), by associating the coupons with a retail loyalty card (e.g., a key fob presented by the user during check-out), loyalty program, or account of the user. The retail application can further notify the user of events, such as product releases, sales, or the like.

The retail application generally obtains the retail information (e.g., information on the retailer's products, services, and other offerings, store locations, policies, or the like) and offer information (e.g., information on the retailer's sales, special offers, coupons, events, or the like) from a web-connected server run by or in association with the retailer. The information is generally retrieved using the mobile station's data communication service, although the information can also be retrieved using the mobile station's Wi-Fi communication capabilities, messaging capabilities, or the like. The information can be retrieved in response to the retail application being opened or otherwise executed on the mobile station, such as in response to a user command to open the application. The information can also be retrieved on a periodic basis, such as weekly, daily, or hourly.

To obtain the offer information, the retail application connects to or issues a request for information from the retailer's server, and receives retail and/or offer information from the retailer's server. In general, the retail and offer information is received in the mobile station in response to a request for information sent to the retailer's server. In some instances, however, at least some of the retail and offer information is pushed to the user's mobile station by the retailer's server. The pushed information is received in the mobile station in response to the retailer's server transmitting the information without receiving a related request from the user's mobile station, and can be transmitted using messaging services and/or a persistent data link established between the mobile wireless network and the mobile station. The pushed information can be stored in a designated location in memory of the mobile station, and presented to the user when it is received, at a predetermined time indicated by the information, or at a later time in response to an action or request from the user.

Reference now is made in detail to the examples illustrated in the accompanying drawings and discussed below.

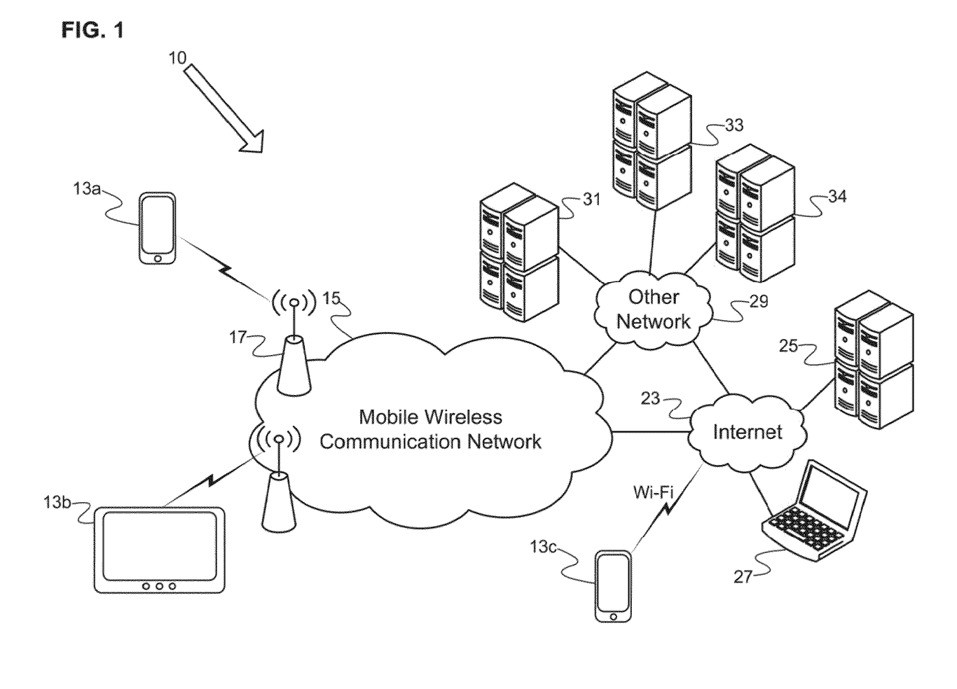

FIG. 1 illustrates a system 10 offering a variety of mobile communication services, including communications in support of providing dynamic management of mobile applications and aggregation of application data for users' mobile station. The example shows three mobile stations 13a, 13b, and 13c as well as a mobile wireless communication network 15. The stations 13a-c are examples of mobile stations that may execute the retail application aggregator configured to dynamically manage and aggregate application data of retail applications running on the stations. The network 15 provides mobile wireless communications services to those stations as well as to other mobile stations (not shown) via a number of base stations (BSs) 17. The present techniques may be implemented in any of a variety of available mobile networks 15 and/or on any type of mobile station compatible with such a network 15, and the drawing shows only a very simplified example of a few relevant elements of the network 15.

Some mobile stations 13a-c may be operative to communicate using a variety of communication networks and protocols other than those used for communication through the mobile wireless network 15. For example, as shown for station 13c, at least some mobile stations are additionally or alternatively configured for data communication through a wireless communication link such as a Wi-Fi link. Mobile stations communicating through Wi-Fi communication links may access Internet-connected servers and services directly through the Internet 23, and/or access servers and services provided by a carrier of the mobile wireless network 15 via the Internet 23 and a private network 29 operated by the carrier.

The wireless mobile communication network 15 might be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard or other standards used for public mobile wireless communications. The mobile stations 13a-c are capable of data communications through the network 15, and some stations may additionally be capable of voice telephone communications through the network 15.

The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations 13a-c via the Internet 23 may be with devices like those shown at 25 and 27 as well as with a variety of other types of devices or systems capable of data communications through the various interconnected networks. Data services for the mobile stations 13a-c can additionally be routed directly to the Internet 23 through other types of communication links, such as Wi-Fi links, in situations in which the mobile stations 13a-c are configured for communications across and have access to such links. The mobile stations 13a-c of users can receive applications through the networks 23 and/or 15, such as retail applications and/or a retail application aggregator, and execute the applications written in various programming languages, as discussed more below.

Mobile stations 13a-c can take the form of portable handsets, smart-phones, or personal digital assistants, although they may be implemented in other form factors. For example, mobile stations 13a-c can take the form of tablet computers, such as i-Pads, or other computing devices configured for communication through a mobile wireless communication network 15 and/or other types of wireless communication links. Program applications, including retail applications and the retail application aggregator, can be configured to execute on many different types of mobile stations 13a-c. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 15 can be implemented by a number of interconnected networks. Hence, the overall network 15 may include a number of radio access networks (RANs), as well as regional ground networks interconnecting a number of RANs and a wide area network (WAN) interconnecting the regional ground networks to core network elements. Physical elements of a RAN operated by one of the mobile service providers or carriers include a number of base stations represented in the example by the base stations (BSs) 17. A base station 17 can include a base transceiver system (BTS), which can communicate via an antennae system at the site of the base station and over the air link with one or more of the mobile stations 13a-c, when the mobile stations are within range. Each base station can include a BTS coupled to several antennae mounted on a radio tower within a coverage area often referred to as a “cell.”

The carrier will also operate a number of systems that provide ancillary functions in support of the communications services and/or application services provided to mobile stations 13a-c, and those elements communicate with other nodes or elements of the system 10 via one or more private IP type packet data networks 29 (sometimes referred to as an Intranet). Generally, such systems are part of or connected for communication via the private network 29, although systems outside of the private network could serve the same functions as well. Examples of such systems, in this case operated by the network service provider as part of the overall network 10, which communicate through the intranet type network 29, include one or more application servers 31 and a related authentication server 33.

A mobile station 13a-c communicates over the air with a base station 17 and through the mobile wireless network 15 for various voice and data communications, e.g. services provided by an Internet-connected server 25 and/or an application server 31. Services related to retail applications are generally hosted on Internet-based servers 25 associated with individual retailers and connected for communication via the networks 15 and 23. In some examples, however, services related to retail applications are hosted on a carrier-operated application server 31, for communication via the networks 15 and 29. For example, if the mobile network carrier offers a retail application providing information related to the carrier's own products and services, services related to the retail application may be hosted on an application server 31. In addition, an aggregator server 34 providing services directly to the retail application aggregator running on users' mobile stations 13a-c can be implemented as a server connected to private network 29 or, alternatively, as an Internet-connected server communicating directly through the Internet 23.

To insure that the application services offered by servers 25 and 31 are available to only authorized devices/users, the provider of the application service also deploys an authentication server 33. The authentication server 33 could be a separate physical server as shown, or the authentication server 33 could be implemented as another program module running on the same hardware platform as the server 25 or 31. Essentially, when the server 25 or 31 receives a service request from a client application on a mobile station 13a-c, the server provides appropriate information to the authentication server 33 to allow application server 33 to authenticate the mobile station 13a-c as outlined herein. Upon successful authentication, the server 33 informs the server 25/31, which in turn provides access to the service via data communication through the various communication networks (e.g., 23, 29, and/or 15). A similar authentication function may alternatively or additionally be provided via a separate authentication server (not shown) connected to the Internet 23.

As detailed above, mobile stations 13a-c commonly have a multitude of retail applications running thereon, each providing a user of the mobile station with information on a respective retailer's products and offers. Each retail application retrieves information on current offers extended by a corresponding retailer from the retailer's Internet-connected server (e.g., 25), for presentation to the user. In order to manage the multitude of retail applications, a mobile station 13a-c can additionally have a retail application aggregator installed thereon. The retail application aggregator is, itself, an application running on the mobile station 13a-c. The retail application aggregator, however, monitors the activity of the retail applications running on the mobile station, and manages the notifications provided by the retail applications to the user according to preferences set by the user during the setup of the aggregator.

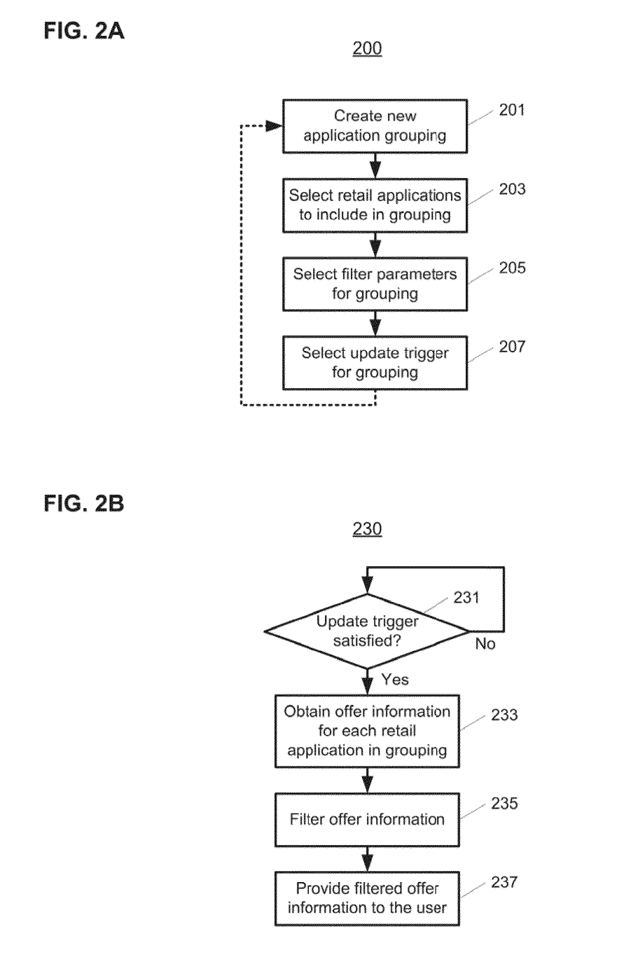

The functions of the retail application aggregator will now be described in more detail in relation to the flow diagrams of FIGS. 2A and 2B.

FIG. 2A is a flow diagram showing steps performed during setup of a retail application aggregator on a mobile station 13a-c. Method 200 details certain steps involved in the setup. Method 200 begins with step 201, in which the user creates a new application grouping. The retail application aggregator can include multiple application groupings, and the user can thus repeat step 201 (and steps 203-207) for each application grouping to be created. For each created application grouping, a record is created in memory to store the name, parameters, and other data associated with the grouping. The application groupings enable the user to classify retail applications previously installed on the mobile station, so as to organize the retail applications according to various themes. As part of step 201, the new grouping can be provided with a name or other descriptor. For example, the user can create a grouping named “Sunday shopping” that includes retail applications of retailers whose stores the user commonly visits on Sunday. The user can additionally or alternatively create groupings according to retailer types (e.g., clothing, grocery, restaurant, home improvement, department store, or the like), locations (e.g., retailers located near home, near work, in a particular mall or neighborhood, or the like), usual shopping time or day (e.g., retailers commonly visited by the user on weekdays, on weekends, during the work day, or in the evening), or any other organizing scheme desired by the user. Different groupings may contain one or more overlapping retailers or may have completely different sets of retailers. Once a grouping is created, an icon for the grouping can be provided on the home screen of the mobile station, in a menu of the mobile station, and/or within a folder of the home screen. The icon can be used by the user to access the grouping and, in turn, to access individual retail applications associated with the grouping.

For each created application grouping, the user performs steps 203-207 to define various parameters and preferences associated with the group. Steps 203-207 can be performed when an application grouping is newly created, and when settings associated with an application grouping are to be updated or adjusted.

In step 203, the user selects retail applications to include in the grouping. For this purpose, the retail application aggregator may perform a scan of the mobile station to identify applications installed on the device. The aggregator may identify all applications installed on the mobile station, all third-party applications installed on the mobile station (e.g., applications not associated with a manufacturer, operating system, or mobile network operator or carrier of the mobile station), or all applications having icons on a home screen or other appropriate menu of the mobile station, for example. Once the applications are identified, the aggregator provides the user with a menu screen listing the identified applications, and prompting the user to select applications to associate with the new application grouping. In one example, all of the identified applications are listed. In other examples, only applications that are not yet associated with a grouping are listed, or those applications associated with other grouping(s) are identified with a characteristic identifier in the list. The user then selects two or more applications to associate with the grouping. The aggregator then updates the record for the new application grouping in memory with identification of the selected applications.

In step 205, the aggregator provides a menu screen prompting the user for filter parameters for the application grouping. The filter parameters are used to identify current offers that may be of interest to the user among the offer information obtained for each of the retail applications in the application grouping. The filter parameters can thus include keywords or description of items and offers of interest to the user (e.g., casual leather shoes, housewares, or the like), of types of offers (e.g., buy one get one free, discounts above $10 or of at least 15% off), of time frames of offer validity (e.g., offers that are valid through next weekend), or any combination thereof. In one example, a user can define filter parameters to identify current offers for casual leather shoes that are at least 15% off. The user can define multiple filter parameters for a particular application grouping, and can link the filter parameters using logical connectors (e.g., AND, OR, AND NOT, or the like).

The filter parameters are presented on the menu screen in step 205 such that the filter parameters are ordered with filter parameters that are most often used being listed before filter parameters that are not used as often. The frequency of use of filter parameters may be evaluated based on the frequency of use of filter parameters currently used or previously used by the user of the mobile station, or by multiple users of the retail application aggregator on various mobile stations based on data obtained by the aggregator server 34. The filter parameters can additionally or alternatively be ordered based on attributes of the application grouping. In one example, upon determining that one application grouping includes one or more retail applications that are also included in another application grouping, filter parameters of the other application grouping may be suggested or prioritized in ordering among filter parameters for the one application grouping. In another example, upon determining that one application grouping primarily includes retail applications for a particular type of retailer (e.g., restaurants, clothing stores, home stores, or the like), filter parameters that are relevant to the identified type of retailer can be prioritized in the ordered list of filter parameters (e.g., if the application grouping is identified as primarily including clothing stores, filter parameters relating to shoes, professional clothes, men's vs. women's wear, or the like, may be prioritized; if the application grouping is identified as primarily including home stores, filter parameters relating to linens, furniture, appliances, kitchen implements, or the like, may be prioritized).

The filter parameters listed on the menu screen can include standard filter parameters, which include standard categories used to identify current offers, and search terms that are commonly used for identifying current offers of interest. The filter parameters listed on the menu screen can also provide users with the opportunity to enter their own personalized search terms, such that users can be notified of offers of specific interest to themselves. The standard categories can include value categories (e.g., ≧10% off, ≧$5 off), item categories (e.g., women's clothing, power tools), period-of-time categories (e.g., offers available today only, offers available through Sunday), or the like. In the case of standard filter parameters (standard categories and/or commonly used search terms), the menu screen can additionally display data on the current and/or historic number of current offers matching the filter parameters, so as to enable the user to ascertain whether the filter parameter will provide excessive, adequate, or insufficient numbers of offers. The data on current and/or historic number of offers matching particular filter parameters can be obtained by the retail application aggregator from the aggregator server 34.

In step 207, the aggregator provides a menu screen prompting the user for trigger parameters for the application grouping. The trigger parameters are used to determine when the retail application aggregator should obtain offer information from each of the retail applications in the grouping. For example, the trigger parameters can be set such that current offers for an application grouping are automatically retrieved on an hourly, daily, weekly, or other pre-scheduled basis (e.g., at 7 am daily, or on the 1^{st} and 15^{th} of each month). The trigger parameters can alternatively or additionally be set based on location (e.g., when I am within 0.5 mile of the shopping mall). The trigger parameters are able to be set independently for each grouping or set of groupings. Alternatively, a single set of trigger parameters may be used for all groupings. If no trigger parameters are selected by the user, a default set may be used based on a computer implemented set, a user-based default set, or the last parameters used, for example.

In one example, a trigger parameter can include receiving a request from the user for updated information on current offers relating to an application grouping. The trigger can be generated in response to the user selecting an icon for the application grouping on a menu screen of the mobile station, and/or selecting an option for receiving updated offer information for the application grouping. In another example, the trigger parameter includes receiving information on current offers automatically transmitted as push-notifications to the mobile station by a retailer's server. In such an example, the offer information is transmitted using push-notifications to the user's mobile station at a time of the retailer's choosing, and receipt of the push notification may cause the retail application aggregator running on a user's mobile station to filter and selectively provide the updated offer information to the user.

In one more example, the trigger parameter includes a position-related trigger, such as a geographical area or boundary. In the example, a position-determining module on a user's mobile station obtains position information for the user's mobile station, and determines whether the user has crossed the geographical boundary associated with the application grouping. If the user has crossed the boundary (and/or entered the geographical area), the trigger parameter is satisfied. The user can thus, for instance, define boundaries surrounding retail stores of all retailers having a retail application in the grouping so as to obtain updated offers from all retail applications in the grouping upon approaching any of the retail stores. In the case of a user selecting an option to define a position-related trigger in step 207, the user is presented with a menu screen enabling the user to define different types of geographical areas or boundaries. In general, the user is provided with the opportunity to define a circular area with a selected radius (e.g., 0.2 miles, 0.5 miles, or 1 mile) around a selected point (e.g., a specific geographic location, such as a location of a store or shopping mall; or any of a plurality of store locations associated with a retailer, such as all Macy's locations). The user can additionally or alternatively define a polygon on a map, as well as an option for the trigger to be associated with entry into or exit from the polygon. Other types of geographical areas or boundaries can also be used.

A trigger parameter, including a position-related trigger or any other trigger, can be defined for an application grouping as a whole, such that all retail applications in the grouping are updated in response to the trigger being satisfied. A trigger can also be associated with multiple application groupings, such that each of the multiple groupings is updated in response to the trigger being satisfied. Additionally, a trigger can be associated with one or more selected retail applications in the grouping, such that only the one or more selected applications are updated in response to the trigger being satisfied. For example, a position-related trigger associated with a Starbucks retail application can be defined with a radius of 0.2 miles surrounding each location of Starbucks, while a different position-related trigger can be defined with a radius of 1 mile for all other retail locations associated with applications in a grouping.

In addition to the specific parameters considered in relation to steps 203-207, the retail application aggregator may allow the user to define additional preferences and parameters not specifically detailed in FIG. 2A. In situations in which retail applications are configured to automatically display notification, e.g. pop-up notifications, on a display screen of the user's mobile station, the retail application aggregator may be operative to block the automatic display of notifications and/or to selectively enable or disable the notifications based on user preferences and settings. In response to receiving a pop-up notification, the aggregator may thus determine an application grouping associated with the retail application for which the notification was received, and may determine whether or not to display the notification based on parameters set for the grouping. In one example, the aggregator may allow the user to indicate whether pop-up notifications from retail applications in a grouping should be allowed or blocked. When allowed, pop-up notifications may be automatically presented on the screen of the mobile station. When blocked, pop-up notifications may not be presented on the screen of the mobile station, but may instead be processed in the background and stored for future consideration by the user.

In another example, the user can select when notifications from retailers in a grouping should be enabled and/or disabled. A user can thus indicate that notifications from a particular grouping should only be displayed during evenings and weekends, such that the user is not interrupted with notifications during the work day but can nonetheless receive notifications promptly at other times. The filtering can thus be performed based on day (e.g., weekend vs. weekday), time slot (defined by start and end times), or the like. The user can additionally indicate that notifications are only to be displayed if the phone is operating under a particular mode or account (e.g., a personal mode), and not be displayed when operating under other modes or accounts (e.g., a work mode and a vacation mode). Notifications that are not displayed can be stored in memory, and displayed at a later time in response to the user accessing the application grouping and selecting to view current offers of the application grouping. When the notifications are displayed, the notifications can be ordered according to various ordering criteria. In one example, the notifications can be ordered chronologically such that notifications that were received earlier (or extended by a retailer earlier) are listed before later notifications. In another example, the notifications can be ordered alphabetically. In a further example, the notifications can be ordered based on user preference data. The user preference data may identify retail applications of particular interest to the user (e.g., retail applications most often accessed by the user, or most often used to make purchases), and prioritize offers associated with those retailers. The user preference data may identify types of offers most often accessed by the user (e.g., offers including particular keywords, offers matching particular filter criteria, or the like) to prioritize offers matching the identified types. Other historical data detailing a user's interactions with offers and applications can further be used as preference data. The prioritization of offers can also be done based on user-selected settings for prioritizing offers, for example based on a user indicating that offers matching a particular filter criteria should be prioritized for presentation over other offers.

Once one or more groupings have been defined and parameters for the grouping have been set, the retail application aggregator is ready for operation. FIG. 2B is a flow diagram showing steps performed by the retail application aggregator during operation. Method 230 of FIG. 2B begins in step 231 with the retail application aggregator monitoring whether a trigger parameter of any of the application groupings on the mobile station has been satisfied. As long as no trigger has been satisfied (step 231, “No”), the retail application aggregator continues monitoring for conditions under which any of the trigger parameters would be satisfied. Once a trigger parameter is satisfied, operation passes to step 233.

In step 233, the retail application aggregator obtains current offer information for each retail application in the grouping. To this end, the aggregator identifies the particular application grouping for which a trigger parameter has been satisfied, and retrieves from memory the list of retail applications associated with the grouping. The aggregator proceeds to access each retail application in the grouping to obtain the offers currently extended by the retailer associated with the retail application.

In general, the aggregator executes each of the retail applications in the application grouping, in order to cause the retail application to retrieve the information on offers currently extended by the respective retailer from the respective retailer's server. The aggregator can sequentially execute each of the retail applications in the background, such that the user of the mobile station can continue to use the mobile station for other purposes while step 233 is being performed. The aggregator stores the obtained information on current offers in memory. In some examples, the aggregator stores text information only, including any metadata associated with images included in the obtained offer information and/or any text information extracted from the images. In other examples, the aggregator stores the images (such as coupon bar or QR codes) included in the obtained offer information in addition to text data.

In situations in which current offer information is automatically provided to the mobile station as push-notifications from the retailer's sever, the aggregator may not need to execute those retail applications configured to receive the push-notifications. Instead, the aggregator may access a memory location associated with the retail application and storing the received push notifications, and may retrieve from the memory location the received information on current offers.

Once information on current offers is obtained in step 233, the aggregator performs step 235. In step 235, the aggregator filters the obtained information on current offers in order to determine whether any of the obtained information is likely to be of interest to the user. The filtering is performed based on the filter parameters for the application grouping that were provided by the user in step 205. The filtering can be performed after completion of step 233, once the information on current offers for each of the retail applications in the grouping has been obtained. Alternatively, the filtering can be performed substantially concurrently with step 233, such that information on current offers is filtered concurrently with or shortly after receipt of the information for each retail application. Information on current offers that does not conform to the filter parameters can optionally be deleted from memory (or not stored in memory following its receipt). Information on current offers that satisfies the filter parameters is stored in memory for later presentation to the user.

In step 237, the filtered offer information is provided to the user. For example, in response to the user selecting an icon for the application grouping on the mobile station, or in response to the user otherwise requesting current offer information for the grouping, a display screen is provided on the mobile station that includes each of the current offers associated with the grouping and satisfying the filter parameters. In one example, only the information on offers satisfying the filter parameters is provided. In another example, the information on offers satisfying the filter parameters is preferentially provided to the user; however, information on all other offers is also available for retrieval from memory and presentation to the user in response to a specific request from the user for information an all offers. In general, the filtered offer information can be ordered according to various ordering criteria, and presented to the user according to the order. Additional detail regarding various ordering criteria is described above in relation to the ordering of notifications. The offer information can be displayed to the user in a list or grid format. The list or grid can include text and/or image information identifying at least one of the retail application or retailer associated with the offer, and information about the offer such as a title and/or summary of the offer. In response to selecting one offer in the list or grid, additional information relating to the offer is presented to the user. In one example, the additional information is text information that was extracted from the current offer and stored in memory, and that includes an icon or link to activate the corresponding retailer's application and/or to access a web page storing additional information about the offer. In another example, the additional information includes a screenshot of the offer that was stored in memory, and/or includes full offer details as they may have been presented to a user receiving the offer notification in real time in a corresponding retail application.

The user's selection of the icon for the grouping can alternatively provide access to a menu screen showing the retail applications included in the grouping, and in which each retail application's icon indicates the number of current offers extended by the corresponding retailer and satisfying the filter parameters. Selection of one retailer's icon causes the user to be presented with those offers from the corresponding retailer that matches the filter parameters. Individual retail applications' icons can be ordered in the menu screen provided in response to selection of an icon for a grouping based on various criteria. In one example, retail applications can be ordered based on the number of current offers extended by the corresponding retailer and satisfying the filter parameters, such that retail applications having one or more current offers are listed before retail applications that have no current offers. In another example, the retail applications can be ordered based on location, such that retail applications corresponding to retailers with store locations close to a current position of the mobile station are listed before detail applications corresponding to retailers with more distal store locations. In a further example, retail applications can be ordered based on retailer type or other retailer characteristics, such that retail applications associated with restaurants can be listed before retail applications associated with stores. Different application groupings may order retail application icons differently. Additionally, different ordering criteria may be used depending on environmental factors (e.g., location, time, weather, or the like), for example such that restaurants are listed before stores at meal times (e.g., during the time periods 7:00 am-8:30 am; 11 am-1 pm; and 6 pm-8 pm) but listed after stores at other times.

In addition to obtaining offer information for each retail application in a grouping, the method 230 can manage information on current offers that is stored on the mobile station. For example, the retail application aggregator may automatically delete information on current offers that was obtained more than one week prior (or any other pre-set time duration prior) to a current time. The retail application aggregator may alternatively or additionally limit the total storage space allotted to information on current offers, and may delete the oldest offer information (e.g., determined based on the time the offer information was received by the mobile station) so as to stay within the allotted storage space. The retail application aggregator may also determine a period of validity of each current offer stored in memory, for example based on date ranges or other time information contained in the offer, and delete the information on offers that are expired or otherwise not currently valid.

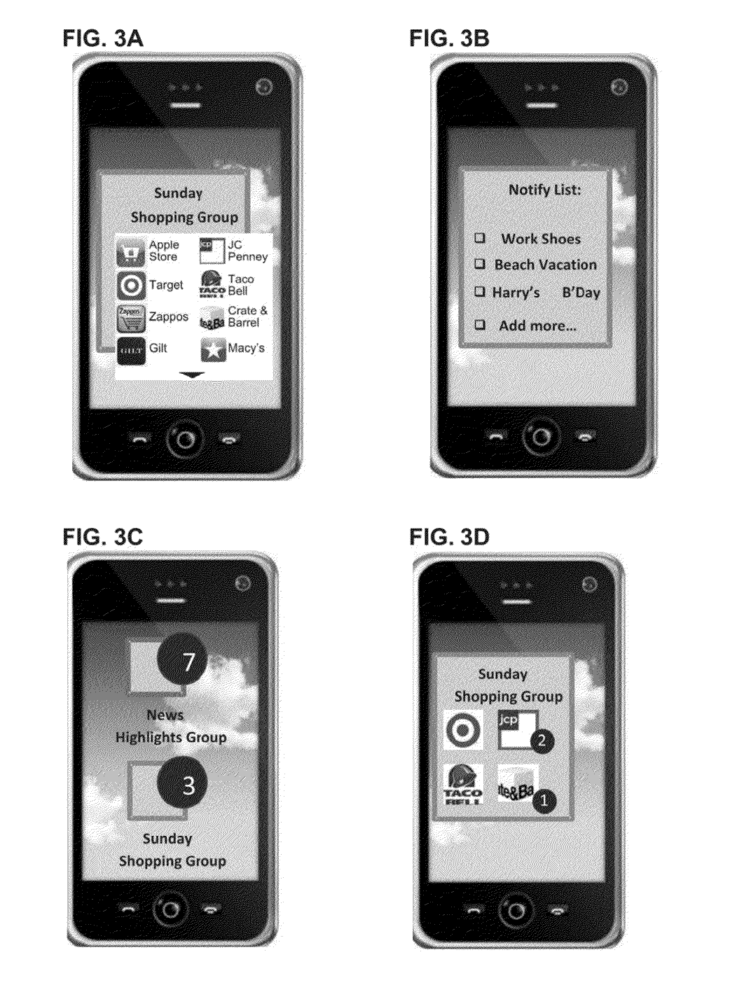

FIGS. 3A-3D are illustrative display screens of a mobile station during setup and use of the retail application aggregator. FIG. 3A shows a display screen that may be displayed during the creation of a new application grouping named “Sunday Shopping Group.” Specifically, the display screen of FIG. 3A may be displayed as part of step 203. The display screen shows a list of applications currently installed on the mobile station and from which the user can select applications to include in the newly created grouping. The user can select among the displayed list of applications two or more applications to include in the grouping. Once the user has finished selecting applications to include in the grouping, the mobile station may display a confirmation screen showing those applications selected by the user for inclusion in the application grouping. If the user is satisfied with the selected applications shown in the confirmation screen, the user can swipe leftwards across the mobile station's screen in order to proceed to the next step of the setup process (e.g., the display screen of FIG. 3B). If the user wants to add or remove applications from the selection, the user swipes rightwards or otherwise accesses an appropriate pop-up or pull-down menu option to return to the previous display screen (e.g., the display screen of FIG. 3A).

FIG. 3B shows a display screen that may be displayed during the step of selecting filter parameters for an application grouping. For example, the display screen of FIG. 3B may be displayed as part of step 205. The display screen shows a list of filter parameters already entered by the user. The user can select or deselect a checkbox next to each parameter to enable or disable the parameter from use. Certain parameters may correspond to terms for filtering offers from retailers. For example, the filter “Beach Vacation” may be used to identify offers that include the string “beach vacation” in the text of the offer and/or in any image or metadata of the offer. Other parameters may correspond to combinations of terms for filtering offers from retailers. For example, the user can select the filter parameter “Harry's B'Day” to access a further display screen (not shown) in which to define a set of multiple terms associated with the filter parameter “Harry's B'Day.” For example, the set of multiple terms can correspond to names of items that may be of interest for a 12 year old boy's birthday, including for example “games for 11-14 year olds,” “electronics for middle school students,” And other terms likely to be found in text, images, and/or metadata of offers of interest

FIG. 3C shows a display screen that may be displayed during operation of a mobile station running a retail application aggregator. In the example of FIG. 3C, the user is provided with an icon corresponding to the application grouping “Sunday Shopping Group,” which can be displayed on the mobile station's home screen. As new offers from retail applications within the grouping are identified by the retail application aggregator, and as the new offers match filter parameters for the grouping, the retail application aggregator updates an icon for the grouping to identify the number of offers (e.g., “3” in the example shown) currently available from the retail applications in the grouping and matching the filter parameters for the grouping. The number of offers shown on the display screen of FIG. 3C can be the number of new offers for the application grouping, corresponding to the number of offers received since a user last accessed the application grouping, the number of offers that the user has not yet reviewed or otherwise been presented with, the number of offers received during a particular time period (e.g., in the last 24 hours; since last Monday morning), the number of offers currently extended by retailers in the application grouping and that are currently valid, or any combination thereof. The display screen can optionally contain additional information, for example by separately listing both the number of new offers associated with an application grouping, and the total number of offers currently extended by retailers of the grouping.

In response to selecting the icon for the application grouping “Sunday Shopping Group” of FIG. 3C, the retail application aggregator can display the illustrative screen of FIG. 3D. In FIG. 3D, icons for each of the retail applications included in the grouping are shown. In the example shown, these correspond to retail applications for the retailers Target, J.C. Penney, Taco Bell, and Crate & Barrel. In addition, those retail applications that have currently available offers matching the filter parameters are shown with a number identifying the number of available offers. As shown, the retail application for J.C. Penney has two offers currently available that may be accessed by selecting the J.C. Penney icon, while Crate & Barrel has one offer currently available.

The retail application aggregator is a standalone application running on the mobile station 13 of a user. The retail application aggregator generally does not require an external server for operation. However, the retail application aggregator can interface with an external aggregator server 34 in order to provide added functionalities to users and retailers. For example, the retail application aggregator can provide the aggregator server 34 with information on the user settings for the aggregator application, and on performance of the aggregator. The retail application aggregator can, in turn, receive software updates and advanced configuration settings from the aggregator server 34 to improve the performance of and user experience provided by the retail application aggregator.

The aggregator server can be a server 34 operated by a carrier of the mobile wireless communication network 15, such as application server 34 connected for communication with mobile station 13a-c through private network 29. The aggregator server can alternatively be an Internet-connected server (e.g., server 25) in communication with mobile stations 13a-c through the Internet 23.

In operation, the retail application aggregator running on a user's mobile station may communicate to the aggregator server information on the settings and performance of the aggregator. The aggregator may thus transmit, following completion of step 203, a message to the aggregator server including the name of an application grouping and identification of retail applications included in the application grouping. Additionally, the aggregator can transmit a message including the filter parameters for the grouping, the trigger parameters, and/or other configuration parameters for an application grouping following the completion of steps 205 and/or 207. Finally, the aggregator can transmit information on a user's interactions with the retail application aggregator and with the current offers accessed through the retail application aggregator, such as information on dates and times when the user accesses data of current offers, information on which current offers are viewed or accessed by the user (including data on a duration of viewing of the offer, data on clicks per action (CPA) and on clicks per impression (CPM), or the like). The aggregator server stores a user profile associated with each user and/or mobile station running the retail application aggregator, and stores the received settings and performance data in association with the corresponding user profile.

The retail application aggregator can additionally provide performance information to the aggregator server 34. For example, the aggregator may transmit to the aggregator server 34 information on offers identified as matching filter parameters following step 235. Additionally, following step 237, the aggregator can provide information on offers displayed to the user, and on user response and interest in the offers (e.g., whether the user spent more than a specified time (e.g., 5 seconds) viewing the offer, whether the user accessed additional information about the offer, whether the user saved the offer or otherwise selected it for future viewing, or the like).

The aggregator server 34 stores the application grouping parameters and the performance information received from the mobile station in a user profile for the mobile station. The aggregator server 34 can then run data analytics on the parameters and performance information, so as to determine the types of offers the user is interested in, the times at (and/or other circumstances in) which the user is most likely to response to offers, or the like. The resulting information, including information on demographics and user psychographics, can be used to identify user behaviors and consumer responsiveness so as to advise retailers on offers of interest to the users for targeted marketing and advertising.

In various examples, the aggregator server may determine that many users have filters for “work shoes,” and may advise retailers to use the string “work shoes” in offers for men's and/or women's dress leather shoes. The aggregator server may further advise retailers on products that users appear to be interested in, based on the configuration settings and user behavioral information, so that the retailers can adjust their offers so as to conform to the users' preferences and thereby attract more potential customers. The aggregator server may additionally provide its own notifications, related to a particular application grouping, based on the known preferences of the user.

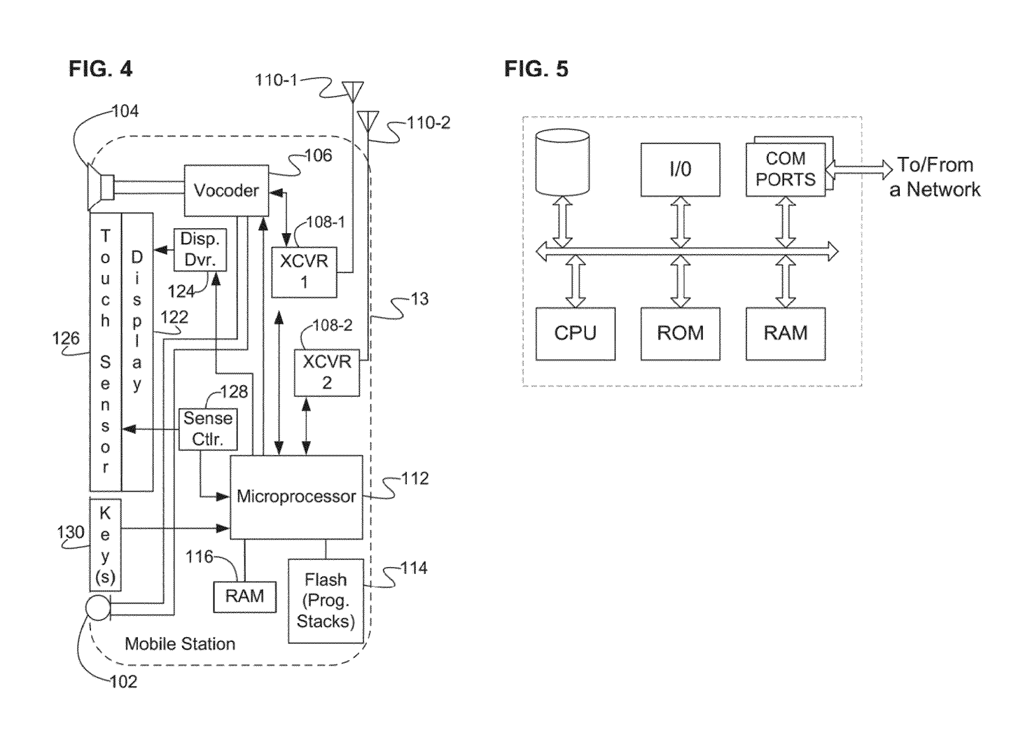

The retail application aggregator under consideration here may be delivered to various types of mobile stations 13a-c, including touch screen type as well as to non-touch type mobile stations. For purposes of illustration, a touch screen type mobile station 13 is shown in FIG. 4. Implementation of the retail application aggregator will involve execution of programming in the mobile station 13, as well as implementation of user input/output functions and data communications through the network 15.

FIG. 4 provides a block diagram illustration of an exemplary touch screen type mobile station 13. Although the mobile station 13 may be a smart-phone, a tablet computer, or may be incorporated into another device, such as a personal digital assistant (PDA) or the like, for discussion purposes, the illustration shows the mobile station 13 is in the form of a smart-phone handset. The smart-phone handset embodiment of the mobile station 13 functions as a normal digital wireless telephone station. For that function, the station 13 includes a microphone 102 and a speaker 104 connected to voice coding and decoding circuitry (vocoder) 106.

For digital wireless communications, the mobile station 13 also includes at least one digital transceiver (XCVR) 108. Today, the mobile station 13 would be configured for digital wireless communications using one or more of the common network technology types. The concepts discussed here encompass embodiments of the mobile station 13 utilizing any digital transceivers that conform to current or future developed digital wireless communication standards. The mobile station 13 may also be capable of analog operation via a legacy network technology. The mobile station 13 may also include multiple transceivers for communication across various types of wireless communication networks, such as one transceiver for communication across mobile wireless communication networks and another transceiver for communication across Wi-Fi networks.

For example, a first transceiver 108-1 provides two-way wireless communication of information, such as vocoded speech samples and/or digital information, in accordance with the technology of the network 15. The first transceiver 108-1 also sends and receives a variety of signaling messages in support of the various voice and data services provided via the mobile station 13 and the communication network. The first transceiver 108-1 connects through RF send and receive amplifiers (not separately shown) to an antenna 110-1. The transceiver may also support various types of mobile messaging services, such as short message service (SMS), enhanced messaging service (EMS) and/or multimedia messaging service (MMS). In addition, an optional second transceiver 108-1 provides two-way wireless communication of information across Wi-Fi links to the Internet 23. The second transceiver connects to and communicates through a second antenna 110-2. The transceiver(s) 108-1 and 108-2 form a wireless communication interface through which the mobile station 13 can communicate through a mobile wireless communication network (e.g., using transceiver 108-1) and/or other type(s) of wireless communication networks (e.g., using transceiver 108-2).

The mobile station 13 includes a display 122 for displaying messages, menus, or the like, including display screens generated by the retail application aggregator and/or retail applications running on the mobile station 13. Key(s) 130 and a touch sensor 126 provide a user input interface for receiving selection inputs, for example, as may be keyed-in by the user based on a displayed menu and selection of a highlighted item on a displayed screen. The display 122, key(s) 130, and touch sensor 126 are the physical elements of a user interface providing both input and output functionalities. Various combinations of the microphone 102 and speaker 104 may additionally be used as input and output components of the user interface. Of course other user interface elements may be used, such as a trackball, as in some types of PDAs or smart phones.

A microprocessor 112 serves as a programmable controller for the mobile station 13, in that it controls all operations of the mobile station 13 in accord with programming that it executes, for all normal operations, and for operations involved in execution of the retail application aggregator under consideration here. In the example, the mobile station 13 includes flash type program memory 114, for storage of various “software” or “firmware” program routines and configuration settings. The mobile station 13 may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, and any of a wide variety of other applications, such as client browser software and short message service software. The memories 114, 116 also store various data, such as server addresses, downloaded data such as multimedia content, configuration data and offer information stored by the retail application aggregator, and various data input by the user. Programming stored in the flash type program memory 114, sometimes referred to as “firmware,” is loaded into and executed by the microprocessor 112.

As outlined above, the mobile station 13 includes a processor, and programming stored in the flash memory 114 configures the processor so that the mobile station is capable of performing various desired functions, including in this case the functions involved in the retail application aggregator providing dynamic management of retail applications and aggregation of application data.

As shown by the above discussion, functions relating to the enhanced dynamic management of retail applications and aggregation of application data, via a graphical user interface of a mobile station, may be implemented on computers connected for data communication via the components of a packet data network. At least some of the functions may be performed by, or supported by processing devices commonly used to run “server” programming so as to implement the aggregator server or retailer server functions discussed above, albeit with an appropriate network connection for data communication.

FIG. 5 provides a functional block diagram illustration of a general purpose computer hardware platform of a network or host computer platform, as may typically be used to implement a server. A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. Of course, the server functions may be implemented in a distributed fashion on a number of similar platforms, to distribute the processing load.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A mobile station comprising:
a processor;
a user interface for receiving commands from a user and displaying information to the user;
a mobile wireless communication interface for communicating across a mobile wireless communication network with the Internet; and
a memory storing instructions for execution on the processor, wherein execution of the instructions causes the processor to:
responsive to receiving through the user interface a user command identifying a plurality of retail applications stored in the memory and configured for execution by the processor, store in the memory an application grouping identifying each of the plurality of retail applications;
associate, with the stored application grouping, filter parameters for identifying content of interest to the user;
for each respective one of the plurality of retail applications in the application grouping, access the respective one retail application to obtain information on current offers extended by a retailer associated with the respective one retail application,
wherein the information on current offers is obtained from an Internet-connected server associated with the retailer through the mobile wireless communication interface and the mobile wireless communication network;
filter the information on current offers obtained for each of the plurality of retail applications in the application grouping based on the filter parameters associated with the application grouping; and
provide the user with the current offers matching filter parameters associated with the application grouping through the user interface.

2. The mobile station of claim 1, wherein execution of the instructions causes the processor to access each respective one of the plurality of retail applications responsive to receiving through the user interface a request from the user for updated information on current offers extended by each of the retailers associated with retail applications of the plurality of retail applications in the application grouping.

3. The mobile station of claim 1, wherein execution of the instructions causes the processor to access each respective one of the plurality of retail applications responsive to receiving through the mobile wireless communication interface and the mobile wireless communication network information on current offers automatically transmitted as a push-notification to the mobile station by an Internet-connected server associated with a retailer associated with one of the plurality of retail applications in the application grouping.

4. The mobile station of claim 1, wherein execution of the instructions causes the processor to access each respective one of the plurality of retail applications responsive to determining, based on information received from a position-determining module of the mobile station, that the user has crossed a geographical boundary associated with the application grouping.

5. The mobile station of claim 1, wherein the processor accesses a respective one of the plurality of retail applications by retrieving from the memory information on current offers that is automatically transmitted as push-notifications to the mobile station by an Internet-connected server associated with a retailer associated with the respective one retail application.

6. The mobile station of claim 1, wherein the processor accesses a respective one of the plurality of retail applications by executing the respective one retail application in the background in order to cause the retail application to retrieve the information on the current offers from the Internet-connected server associated with the retailer of the respective one retail application through the mobile wireless communication interface and the mobile wireless communication network.

7. The mobile station of claim 1, wherein execution of the instructions further causes the processor to:
receive through the mobile wireless communication interface and the mobile wireless communication network information on a current offer automatically transmitted as a push-notification to the mobile station by an Internet-connected server associated with a retailer;
identify, from among a plurality of application groupings stored in the memory, the application grouping associated with the retail application of the retailer from which the push-notification was received; and
prevent display of a pop-up notification included in the received push-notification upon determining that pop-up notifications for the identified application grouping are disabled.

8. The mobile station of claim 1, wherein execution of the instructions further causes the processor to:
following the storing in the memory of the application grouping identifying each of the plurality of retail applications, generate and transmit across the mobile wireless network to an aggregator server a notification message identifying the mobile station and the plurality of retail applications included in the application grouping.

9. A method comprising:
responsive to receiving through a user interface of a mobile station a user command identifying a plurality of retail applications stored in a memory of the mobile station and configured for execution by a processor of the mobile station, storing in the memory an application grouping identifying each of the plurality of retail applications;
associating, with the stored application grouping, filter parameters for identifying content of interest to a user of the mobile station;
for each respective one of the plurality of retail applications in the application grouping, accessing the respective one retail application to obtain information on current offers extended by a retailer associated with the respective one retail application,
wherein the information on current offers is obtained from an Internet-connected server associated with the retailer through a mobile wireless communication interface of the mobile station and a mobile wireless communication network connected to an Internet;
filtering the information on current offers obtained for each of the plurality of retail applications in the application grouping based on the filter parameters associated with the application grouping; and
providing the user with the current offers matching filter parameters associated with the application grouping through the user interface.

10. The method claim 9, wherein a respective one of the plurality of retail applications is accessed responsive to receiving through the user interface a request from the user for updated information on current offers extended by each of the retailers associated with retail applications of the plurality of retail applications in the application grouping.

11. The method of claim 9, wherein a respective one of the plurality of retail applications is accessed responsive to receiving through the mobile wireless communication interface and the mobile wireless communication network information on current offers automatically transmitted as a push-notification to the mobile station by an Internet-connected server associated with a retailer associated with one of the plurality of retail applications in the application grouping.

12. The method of claim 9, wherein a respective one of the plurality of retail applications is accessed responsive to determining, based on information received from a position-determining module of the mobile station, that the user has crossed a geographical boundary associated with the application grouping.

13. The method of claim 9, wherein accessing a respective one of the plurality of retail applications comprises retrieving from the memory information on current offers that is automatically transmitted as push-notifications to the mobile station by an Internet-connected server associated with a retailer associated with the respective one retail application.

14. The method of claim 9, wherein accessing a respective one of the plurality of retail applications comprises executing the respective one retail application in the background in order to cause the retail application to retrieve the information on the current offers from the Internet-connected server associated with the retailer of the respective one retail application through the mobile wireless communication interface and the mobile wireless communication network.

15. The method of claim 9, further comprising:
receiving through the mobile wireless communication interface and the mobile wireless communication network information on a current offer automatically transmitted as a push-notification to the mobile station by an Internet-connected server associated with a retailer;
identifying, from among a plurality of application groupings stored in the memory of the mobile station, the application grouping associated with the retail application of the retailer from which the push-notification was received; and
preventing display of a pop-up notification included in the received push-notification upon determining that pop-up notifications for the identified application grouping are disabled.

16. The method of claim 9, further comprising:
following the storing in the memory of the application grouping identifying each of the plurality of retail applications, generating and transmitting across the mobile wireless network to an aggregator server a notification message identifying the mobile station and the plurality of retail applications included in the application grouping.
